(19) United States
(12) Patent Application Publication
(10) Pub. No.: US 2025/0241319 A1
(43) Pub. Date: Jul. 31, 2025

(54) CONFECTION SPREADER

(71) Applicant: JFL Enterprises, Inc., Cleveland, OH (US)

(72) Inventors: David Kunitz, Barrington, RI (US); Scott Shahmanesh, New York, NY (US)

(73) Assignee: JFL Enterprises, Inc., Cleveland, OH (US)

(21) Appl. No.: 19/039,891

(22) Filed: Jan. 29, 2025

Related U.S. Application Data
(60) Provisional application No. 63/626,296, filed on Jan. 29, 2024.

(51) Int. Cl. A21C 15/00

(52) U.S. Cl. CPC A21C 15/002

(57) ABSTRACT

A confection spreader may be configured to spread confections (for example sprinkles), for example over a cake. The spreader includes a confection tray that is initially in an upper position on a post, mechanically coupled to an upper tray which supports a confection housing or reservoir in which the confections are initially located. At the bottom of posts are legs that act as a stand for the confection spreader. The post includes a spiral groove that is engaged by the confection tray, such that when a lock holding the confection tray against the upper tray is released, the confection tray spins as it descends along the post, following the spiral groove. The release of the confection tray allows confections to flow out of the confection reservoir, through openings in the upper tray, and onto the confection tray. As the confection tray rotates, the confections are propelled outward by centrifugal forces.

This application claims priority to U.S. Provisional Application 63/626,296, filed Jan. 29, 2024, the entire disclosure of which is incorporated by reference in its entirety.

### FIELD

The disclosure is in the field of devices and methods for spreading confections, such as on a cake.

### BACKGROUND

Celebrations of life events are important to most people, and birthdays are probably the most frequent of those celebrations in most people's lives. Birthdays are a time festive and colorful directions, for candles and wishes, and yes, for cake. Anything that would improve such celebrations, and the characteristics of such celebrations, is desirable, to the point of being itself an occasion for celebration.

### SUMMARY

According to an aspect of the disclosure, a confection spreader includes: a post; and a confection tray operably coupled to the post; wherein the confection tray spins relative to the post as the tray descends on the post, spreading confections that are on the confection tray.

According to an embodiment of any paragraph(s) of this summary, the confection tray includes a protrusion that engages a groove on the post.

According to an embodiment of any paragraph(s) of this summary, the protrusion is an inward protrusion into a central hole of the confection tray through which the post passes.

According to an embodiment of any paragraph(s) of this summary, the groove includes a spiral groove portion around the post.

According to an embodiment of any paragraph(s) of this summary, the groove includes a helical groove portion around the post.

According to an embodiment of any paragraph(s) of this summary, the groove has a vertical top portion.

According to an embodiment of any paragraph(s) of this summary, the confection tray has holes therein for passage of the confections therethrough out of the confection tray.

According to an embodiment of any paragraph(s) of this summary, the confection tray has deflectors outboard of the holes through which the confections pass.

According to an embodiment of any paragraph(s) of this summary, the deflectors are circumferential portions of the confection tray.

According to an embodiment of any paragraph(s) of this summary, the deflectors are oriented primarily vertically (axially), directing the confections in a downward direction out of the confection tray.

According to an embodiment of any paragraph(s) of this summary, an upper surface of the tray is contoured, with pockets defined by the upper surface that direct the confections outward toward the holes.

According to an embodiment of any paragraph(s) of this summary, the tray has upward protrusions.

According to an embodiment of any paragraph(s) of this summary, the spreader further includes a reservoir for the confections, wherein the reservoir is configured to supply the confections to the confection tray.

According to an embodiment of any paragraph(s) of this summary, the reservoir is fixed relative to the post.

According to an embodiment of any paragraph(s) of this summary, the reservoir is conical.

According to an embodiment of any paragraph(s) of this summary, the reservoir has an open top that is wider than a bottom of the reservoir.

According to an embodiment of any paragraph(s) of this summary, the spreader further included an upper tray.

According to an embodiment of any paragraph(s) of this summary, the upper tray is fixedly attached to the post.

According to an embodiment of any paragraph(s) of this summary, the reservoir is attached to the upper tray.

According to an embodiment of any paragraph(s) of this summary, the upper tray has posts configured for receiving candles.

According to an embodiment of any paragraph(s) of this summary, the candle-receiving posts are circumferentially evenly spread around a perimeter of the upper tray.

According to an embodiment of any paragraph(s) of this summary, the upper tray is releasably coupled to the confection tray.

According to an embodiment of any paragraph(s) of this summary, the spreader further includes a lock that releasably couples the confection tray to the upper tray.

According to an embodiment of any paragraph(s) of this summary, the reservoir is attached to the upper tray.

According to an embodiment of any paragraph(s) of this summary, the upper tray has openings configured to pass the confections from the reservoir to the confection tray.

According to an embodiment of any paragraph(s) of this summary, the openings in the upper tray are circumferentially spaced around a central hub of the upper tray that is attached to a top of the post.

According to an embodiment of any paragraph(s) of this summary, when the confection tray is in an upper position against the upper tray, prior to the beginning of the spinning of the confection tray as the confection tray descends the post, the confection tray blocks the openings in the upper tray, keeping the confections from passing through the openings in the upper tray.

According to an embodiment of any paragraph(s) of this summary, the spreader further includes a lock that releasably maintains the confection tray in the upper position.

According to an embodiment of any paragraph(s) of this summary, the lock includes a mechanical lock.

According to an embodiment of any paragraph(s) of this summary, the mechanical lock includes a lever that is in an engaged position to lock the confection tray in the upper position, and is rotated to unlock the confection tray, to separate the confection tray from the upper tray.

According to an embodiment of any paragraph(s) of this summary, the lock includes a tie that passes through holes in the upper tray and the confection tray, holding the confection tray in the upper position.

According to an embodiment of any paragraph(s) of this summary, the tie is a string.

According to an embodiment of any paragraph(s) of this summary, the tie is operatively coupled to a burnable fuse that, when burned, severs the tie, thereby releasing the confection tray from upper tray.

According to an embodiment of any paragraph(s) of this summary, the lock includes a locking means that releasably maintains the confection tray in the upper position.

According to an embodiment of any paragraph(s) of this summary, the post is a multipart post, with an upper post portion coupled to a lower post portion.

According to an embodiment of any paragraph(s) of this summary, the spreader further includes legs mechanically coupled to a bottom of the post.

According to an embodiment of any paragraph(s) of this summary, the legs are L-shape legs.

According to an embodiment of any paragraph(s) of this summary, the legs include four legs.

According to an embodiment of any paragraph(s) of this summary, the four legs are in a pair of leg pieces, each of which includes two of the legs.

According to an embodiment of any paragraph(s) of this summary, the leg pieces are perpendicular to each other, putting the four legs in a cruciform configuration.

According to an embodiment of any paragraph(s) of this summary, the spreader further includes a base that couples the leg pieces to the bottom of the post.

According to an embodiment of any paragraph(s) of this summary, one or more of the post portions, the trays, and the leg pieces are made of plastic.

According to another aspect, a method of spreading confections includes: rotating a tray containing the confections as the tray descends along a post; wherein the rotation causes the confections to drop through openings in the tray.

According to an embodiment of any paragraph(s) of this summary, the confections are sprinkles.

According to an embodiment of any paragraph(s) of this summary, the confections are spread upon a cake that is beneath the tray.

According to an embodiment of any paragraph(s) of this summary, the tray and the post are parts of a confection spreader, which may include other features as described in any paragraph(s) of this summary.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1 is an oblique view of a confection spreader according to an embodiment of the present disclosure.

FIG. 2 is an exploded view of the confection spreader of FIG. 1.

FIG. 3 is an oblique view of the top of the confection tray of the spreader of FIG. 1.

FIG. 4 is an oblique view of the bottom of the confection tray of FIG. 3.

FIG. 5 is an exploded view of the post and the base of the spreader of FIG. 1.

FIG. 6 is an oblique exploded view of the top of the reservoir and the upper tray of the confection spreader of FIG. 1.

FIG. 7 is an oblique view showing the bottom of the upper tray of FIG. 6.

FIG. 8 is an exploded view of the lock of the spreader of FIG. 1.

### DETAILED DESCRIPTION

A confection spreader may be configured to spread confections (for example sprinkles), for example over a cake, such as a birthday cake. The spreader includes a confection tray that is initially in an upper position on a post, mechanically coupled to an upper tray which supports a confection housing or reservoir in which the confections are initially located. At the bottom of posts are legs that act as a stand for the confection spreader. The post includes a spiral groove that is engaged by the confection tray, such that when a lock holding the confection tray against the upper tray is released, the confection tray spins as it descends along the post, following the spiral groove. The release of the confection tray allows confections to flow out of the confection reservoir, through openings in the upper tray, and onto the confection tray. As the confection tray rotates, the confections are propelled outward by centrifugal forces, exiting the confection tray in an outward and downward direction through openings in the confection tray. This spreads the confections on a cake (for example) that is below the confection tray, for example supported by the base of the confection spreader.

The releasable lock holding the confection tray initially against the upper tray (and thereby blocking flow of confections) may include one or more lock mechanisms, such as a burnable fuse and/or a releasable mechanical engagement. The burnable fuse mechanism may involve a string that passes through holes in the upper tray and the confection tray, tying the two together. Burning of the fuse eventually causes the string to be burned through, releasing the confection tray to spin downward along the post (and starting the flow of confections).

The mechanical lock mechanism may involve a lever that causes a protrusion on the lock to engage a depression or detent in a part of the confection tray, preventing rotation of the confection tray. Rotation of the lever disengages the mechanical lock, allowing the confection tray to rotate downward along the post, away from the upper tray, to spread the confections.

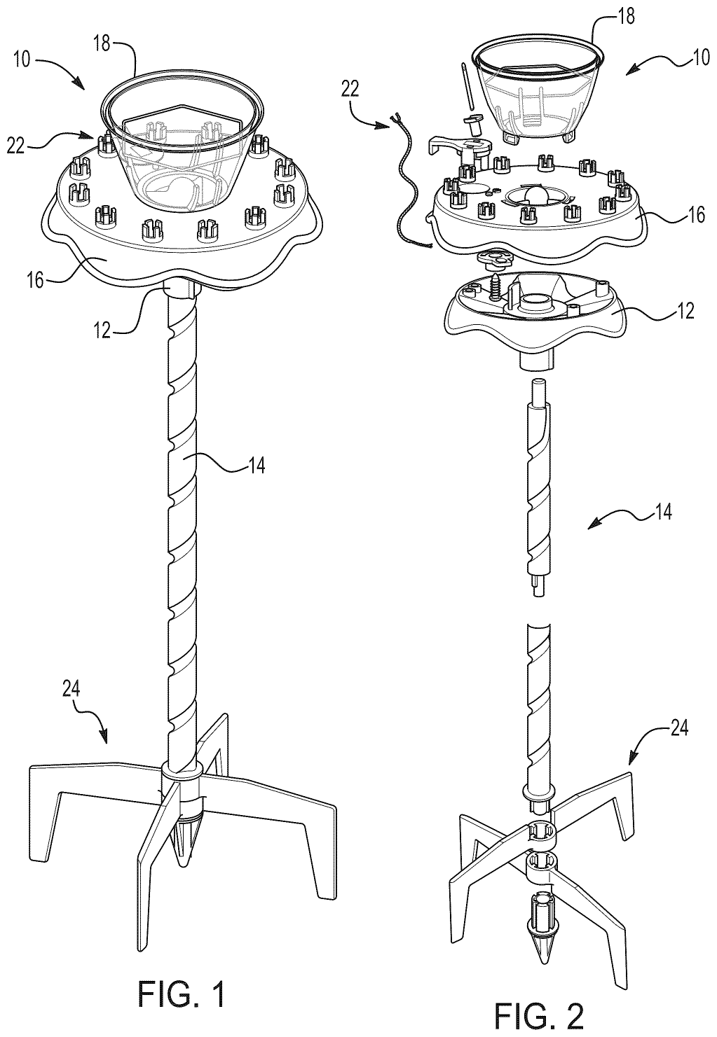

Referring initially to FIGS. 1 and 2, a confection spreader 10 is used for spreading confections, such as sprinkles, on an objection, such as a cake. A confection tray 12 is configured to initially be locked in an upper position on a post 14, against an upper tray 16. The upper tray 16 has a confection housing or reservoir 18 where the confections are initially located.

A lock 22 keeps the confection tray 12 in the upper position on the post 14, prior to its release for spreading the confections. A base 24 is at the bottom of the post 14, providing a stand for the spreader 10 on a surface such as a table.

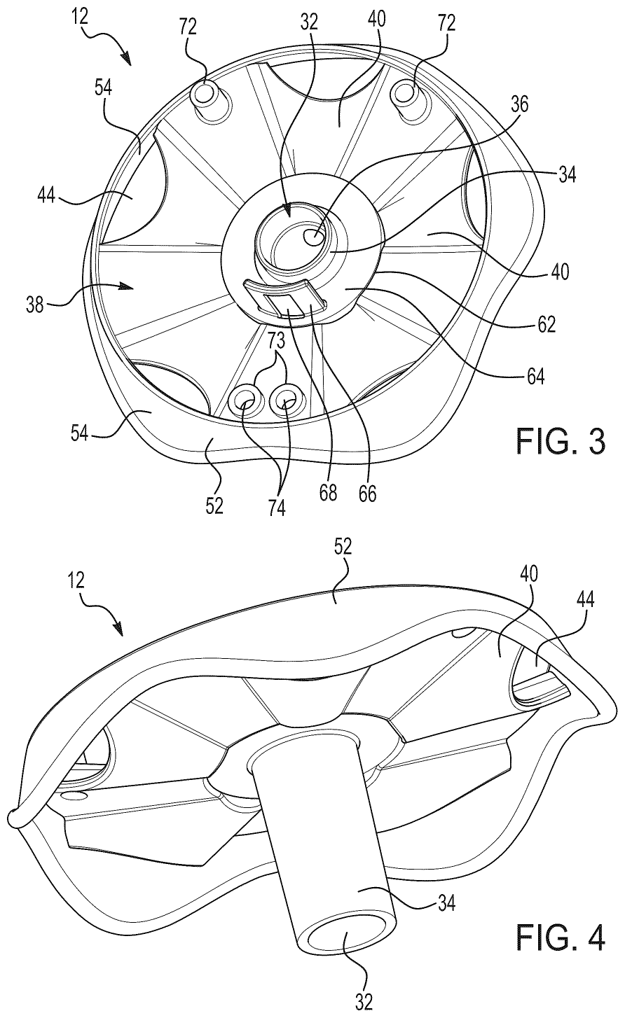

The parts of the confection spreader 10 are now discussed in greater detail. Referring now in addition to FIGS. 3 and 4, the confection tray 12 has a central hole 32, surrounded by a hollow hub 34, which allows the post 14 (FIG. 1) to pass therethrough. An inward protrusion 36 from the hub 34, into the central hole 32, is used to engage a groove in the post 14, as described further below.

The confection tray 12 has a contoured top surface 38, with a series of recessed pockets 40 therein, which direct confections downward and radially outward toward holes 44, through which confections pass to sprinkle down upon an item to be decorated, such as a cake. The confection holes 44 are in an outer portion of the confection 12, and may be evenly circumferentially spaced about a perimeter of the confection tray 12. The confection holes 44 may have rounded borders.

The confection tray 12 has a perimetrical outer rim 52. Parts of the rim 52 adjoining the confection holes 44 act as deflectors 54 to deflect confections downward through the confection holes 44. The deflectors 54 deflect the confections toward the object to be decorated, and may prevent the confections from exiting the confection tray 52 in a radial direction, or with excessive velocity in a radial direction, thereby being projected beyond the object to be decorated, and making a mess of things. The deflectors 54 may have a vertical or substantially vertical or primarily vertical orientation, for example being angled downward and radially outward, to direct the confections in a downward direction, perhaps with some radially outward velocity.

The confection tray 12 has an inner ledge 62, around the hollow hub 34, that provides a horizontal annular flat top surface 64 around the hub 34. This flat top surface 64 is used to block the flow of confections from the upper tray 16 (FIG. 1) when the confection tray 12 is in the upper position, against the upper tray 16. A vertical protrusion 66 protrudes upward from the top surface 64 of the inner ledge 62. The protrusion 66 has a curved shape, and is configured to fit in an opening of the upper tray 16, as described further below. The protrusion 66 has a recess or detent 68 that is part of a mechanical locking mechanism, as described further below.

The confection tray 12 also has a series of hollow upward protrusions 72 that are configured to contact a bottom surface of the upper tray 16 when the confection tray 12 is in the upper position against the upper tray 16. Two further protrusions 73 also define a pair of holes 74 that are part of a locking and release fuse mechanism for releasing the confection tray 12.

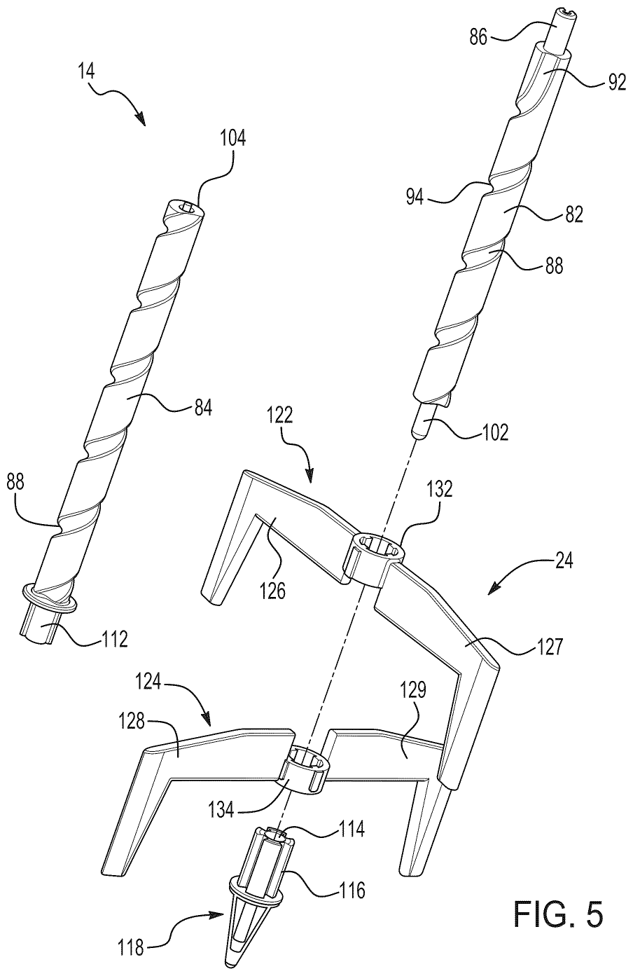

With reference to FIG. 5, details of the post 14 and the base 24 are now discussed. The post 14 includes an upper post portion 82 and a lower post portion 84. The upper post portion 82 has an upward-protruding pin 86 at an upper end of the post 14, for engaging with a hub of the upper tray 16 (FIG. 1), described below. The pin 86 may be keyed so as to prevent rotation of the upper tray 16 relative to the post 14.

The post 14 defines a groove 88 that extends along both of the post portions 82 and 84. The groove 88 is engaged by inward protrusion 36 (FIG. 3) of the confection tray 12 (FIG. 3), to guide movement of the confection tray 12 as the confection tray 12 moves (or slides) down the post 14. The groove 88 has a vertical (or substantially vertical, or mostly vertical) top portion 92 at the upper end of the post 14. This vertical (or mostly vertical) groove portion 92 provides (downward) acceleration to the confection tray 12 when the confection tray 12 is released to move, and allows the vertical protrusion 66 (FIG. 3) of the confection tray 12 to clear the opening of the upper tray 16 (FIG. 1).

The top portion 92 of the groove 88 then transitions to a spiral groove portion 94 that extends down almost all of the remainder of the length of the post 14. There may be a keyed connection between the post portions 82 and 84, with a protrusion 102 in one of the post portions 82 and 84 engaging a correspondingly-spaced recess 104 in the other of the post portions 82 and 84. This keying may be advantageous in that it provides alignment between the post portions 82 and 84 so that the spiral groove portion 94 remains continuous at the transition between the post portions 82 and 84. There may be a press fit between the post portions 82 and 84.

The bottom post portion 84 has a bottom keyed pin 112 for receiving the base 24, and in particular for engaging a corresponding recess 114 in a protrusion 116 in a bottom part 118 of the base 24. The base bottom part 118 secures a pair of leg pieces 122 and 124 to the bottom of the post 14. Each of the leg pieces 122 and 124 includes a pair of L-shape legs on opposite sides of a central axis of the device, such as the legs 126 and 127 of the leg piece 122, and the legs 128 and 129 of the leg piece 124. The leg pieces 122 and 124 have corresponding internally-keyed collars 132 and 134. The collars 132 and 134 are stacked on one another, with the leg pieces 122 and 124 perpendicular to one another. The leg pieces 122 and 124 are secured to the bottom of the post 14 using the base bottom part 118, with the base bottom protrusion 116 passing through the keyed holes in the collars 132 and 134, and the post bottom pin 112 being inserted into the recess 114 in the base bottom part 118.

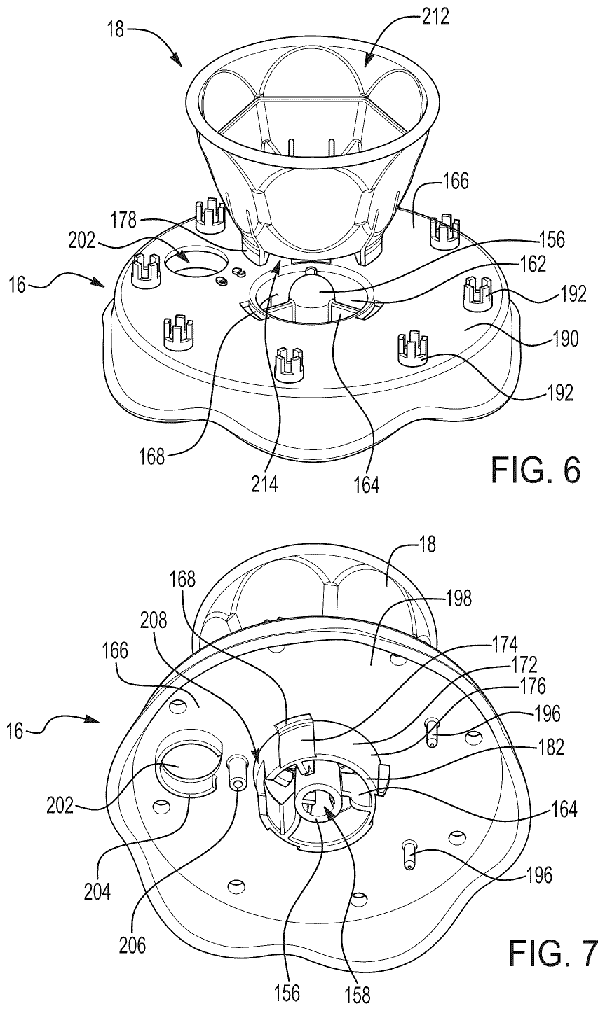

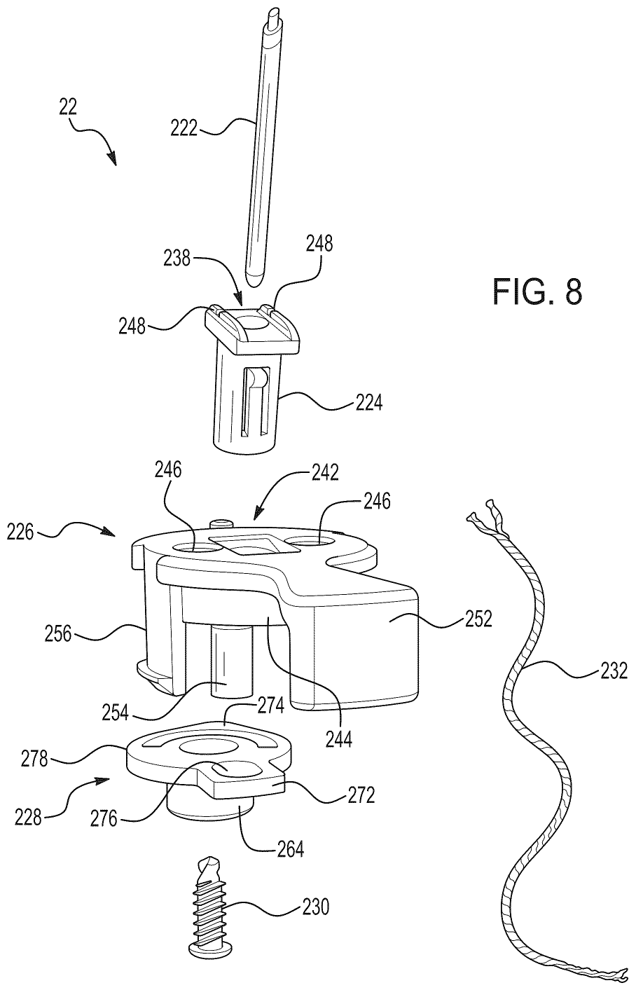

Turning now to FIGS. 6 and 7, the upper tray 16 and the confection reservoir 18 are now described in greater detail. The upper tray 16 has a central hub 156, the underside of which has a keyed recess 158 for engaging the upper post portion 82 (FIG. 5) of the post 14 (FIG. 5). An annular opening 162 surrounds the central hub 156, with struts 164 across the annular opening 162 connecting the central hub 156 to an upper tray body 166.

The upper tray body 166 has slots 168 just radially outward of the annular opening 162. On the underside of the upper tray body 166 there is a collar 172 surrounding the annular opening 162, with depressions or indentations 174 in a radially outer surface 176 of the collar 172 at locations corresponding to the location of the slots 168. The slots 168 are configured to receive resilient hooked tabs 178 along a bottom of the reservoir 18, for coupling the reservoir 18 to the upper tray 16. The tabs 178 enter the slots 168 as the reservoir 18 is pushed down onto the upper tray 16. The tabs 178 resiliently bend outward as they run along the indentations 174, and the hooks of the tabs 178 snap inward to engage a bottom surface edge 182 of the collar 172, securing the reservoir 18 to the upper tray 16.

A series of posts are circumferentially spaced in groups around a perimeter of a top surface 190 of the upper tray 16, each of the groups constituting a holder 192. Each of the holders 192 is configured for receiving and holding an object therein, the groups of posts being configured for example for receiving birthday candles.

Protrusions 196 on a bottom surface 198 of the upper tray 16 are used to support the connection between the upper tray 16 and the confection tray 12 (FIG. 3) when the trays 12 and 16 are coupled together. The protrusions 196 are used in conjunction with the corresponding hollow protrusions 72 (FIG. 3) of the confection tray 12, when the trays 12 and 16 are coupled together, with the protrusions 196 fitting into the hollow protrusions 72.

The upper tray 16 also has features for receiving the lock 22 (FIGS. 1 and 2). These features include a through-hole 202, a collar 204 extending from the bottom surface 198 surrounding most of the through-hole 202, and a screw-receiving hollow protrusion 206. Another lock-related feature of the upper tray 16 is a window 208 in the collar 172.

The reservoir 18 may be made of a clear, translucent, or tinted material, such as a suitable plastic. The reservoir 18 may have a conical or funnel shape, with a relatively-wide open top 212 of the reservoir 18 wider than a relatively-narrow bottom 214 of the reservoir 18. However, alternatively the reservoir 18 may any of a wide variety of non-conical shapes. The reservoir 18 may be at least in part faceted, with the shape made up of flat facets connected together.

Sprinkles or other confections may be poured into the reservoir's open top 212. In operation the confections pass out of the reservoir 18 through the open bottom 214, then through the annular opening 162 in the upper tray 16, then onto the confection tray 12 (FIG. 3). This flow of the confections is blocked when the confection tray 12 is in the upper position, against the upper tray 16. In that configuration the annular flat top surface 64 of the confection tray 12 blocks the annular opening 162 in the upper tray 16, with the top surface 64 against a bottom edge of the collar 172.

FIG. 8 shows details of the lock 22. The lock 22 includes a pair of lock mechanisms, a burnable fuse release mechanism, and a releasable mechanical lock. The lock 22 includes a burnable fuse 222, a fuse holder 224, a fuse bottom 226 that also operates as a lever, a tray lock 228, a fastener 230, and a retaining string 232.

The fuse 222 is placed an opening 238 in the fuse holder 224, which in turn is inserted into an opening 242 in a central body 244 of the fuse bottom 226. The opening 242 for receiving the fuse holder 224 is between a pair of holes 246 through the central body 244 of the fuse bottom 224. Notches 248 in the fuse holder 224 are configured for receiving the retaining string 232, with ends of the retaining string 232 passing downward through the holes 246. When the confection tray 12 (FIG. 3) is in the upper position on the post FIG. 5, against the bottom of the upper tray 16 (FIG. 7), the holes 244 are aligned with the holes 74 (FIG. 3) through the confection tray 12. The retaining string 232 initially passes through the holes 246 and the holes 74 to tie the confection tray 12 and the upper tray 16 together. When the fuse 222 burns, it eventually burns down to the point where the flame reaches the retaining string 232, between the notches 248, and burns through the retaining string 232. This releases the confection tray 12 from the upper tray 16, allowing the confection tray 12 spin downward along the post 14, starting the flow of the confections onto the confection tray 12, and spreading the confections onto the object to be decorated.

The operation of the releasable mechanical lock mechanism is now described. The fuse bottom 226 includes the central body 244, a lever arm 252 extending radially from the central body 244, a post 254 perpendicular to the lever arm 252 and extending downward in an axial direction, and hooked resilient tab 256 also extending downward, off of a portion of the perimeter of the central body 244. The fuse bottom 226 is installed from the top of the upper tray 12 (FIG. 6), with the central body 244 in the hole 202 (FIG. 6) in the upper tray 12, and the hooked resilient tab 256 engaging a bottom edge of the collar 204 (FIG. 7).

The tray lock 228 includes a tray lock central body 264 that has a through hole 266 therein, a flange 272 extending radially away from the central body 264 in one direction, and a curved cam surface 274 extending radially away from the central body in another direction. The flange 272 has a flange hole 276 therein, and a circumferential slot 278 in the vicinity of the curved cam surface provides some resilient movement of the curved cam surface 274 in a radial direction.

The tray lock 228 is coupled to the hollow protrusion 206 (FIG. 7) that is on the bottom of the upper tray 16 (FIG. 7), using the fastener 230, which may be a suitable screw. The fastener 230 is inserted into the hole 266, and then into the hollow protrusion 206, securing the tray lock central body 264 to the protrusion 206. This coupling allows rotation of the tray lock 228 about the axis of the through hole 266. The post 254 of the fuse bottom 226 fits into the flange offset hole 276 of the tray lock 228. The lever arm 252 may extend off an edge of the upper tray 16, as best shown in FIGS. 1 and 2.

In operation, rotation of the fuse bottom 226 through movement of the lever arm 252 causes a corresponding movement of the post 254. Through engagement with the tray lock flange 272, this causes rotation of the tray lock 228 about its axis. This in turn causes the curved cam surface 274 to engage or disengage, through the window 206 (FIG. 7) with the recess or detent 68 (FIG. 3) in the protrusion 66 (FIG. 3) of the confection tray 12 (FIG. 3). This allows a user to manually lock the trays 12 and 16 together, or to release the confection tray 12 from the upper tray 16 (FIG. 6).

It should be appreciated that either one of the lock mechanisms would be sufficient for operation. However the burning fuse lock mechanism makes for a more impressive display, for example complementing burning birthday candles. And the mechanical mechanism has the advantage of being reusable, without any need to replace parts such as the fuse and retaining string. Therefore it is advantageous to have both lock mechanisms in the same device.

Many of the parts of the spreader 10 (FIG. 1) may be made of suitable plastics. For example the confection tray 12, the post 14, the upper tray 16, the reservoir 18, the base 20, and/or many parts of the fuse 22, may be made of suitable plastic materials.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

What is claimed is:

1. A confection spreader comprising:
a post; and
a confection tray operably coupled to the post;
wherein the confection tray spins relative to the post as the tray descends on the post, spreading confections that are on the confection tray.

2. The spreader of claim 1, wherein the confection tray includes a protrusion that engages a groove on the post.

3. The spreader of claim 2, wherein the groove includes a spiral groove portion around the post.

4. The spreader of claim 3, wherein the groove has a vertical top portion.

5. The spreader of claim 1, wherein the confection tray has holes therein for passage of the confections therethrough out of the confection tray.

6. The spreader of claim 5, wherein the confection tray has deflectors outboard of the holes through which the confections pass.

7. The spreader of claim 6, wherein the deflectors are oriented primarily vertically (axially), directing the confections in a downward direction out of the confection tray.

8. The spreader of claim 1, wherein the confection tray has upward protrusions.

9. The spreader of claim 1, further comprising a reservoir for the confections, wherein the reservoir is configured to supply the confections to the confection tray.

10. The spreader of claim 1, further comprising an upper tray that is fixedly attached to the post.

11. The spreader of claim 10,
further comprising a reservoir for the confections, wherein the reservoir is configured to supply the confections to the confection tray;
wherein the reservoir is attached to the upper tray.

12. The spreader of claim 10, wherein the upper tray has posts configured for receiving candles.

13. The spreader of claim 10, wherein the upper tray is releasably coupled to the confection tray.

14. The spreader of claim 10, wherein the upper tray has openings configured to pass the confections from the reservoir to the confection tray.

15. The spreader of claim 14, wherein the openings in the upper tray are circumferentially spaced around a central hub of the upper tray that is attached to a top of the post.

16. The spreader of claim 10, wherein, when the confection tray is in an upper position against the upper tray, prior to the beginning of the spinning of the confection tray as the confection tray descends the post, the confection tray blocks the openings in the upper tray, keeping the confections from passing through the openings in the upper tray.

17. The spreader of claim 16, further comprising a lock that releasably maintains the confection tray in the upper position.

18. The spreader of claim 17,
wherein the lock includes a mechanical lock; and
wherein the mechanical lock includes a lever that is in an engaged position to lock the confection tray in the upper position, and is rotated to unlock the confection tray, to separate the confection tray from the upper tray.

19. The spreader of claim 17,
wherein the lock includes a tie that passes through holes in the upper tray and the confection tray, holding the confection tray in the upper position; and
wherein the tie is operatively coupled to a burnable fuse that, when burned, severs the tie, thereby releasing the confection tray from upper tray.

20. A method of spreading confections comprises:
rotating a tray containing the confections as the tray descends along a post;
wherein the rotation causes the confections to drop through openings in the tray.
